(19) United States
(12) Patent Application Publication
(10) Pub. No.: US 2018/0299120 A1
(43) Pub. Date: Oct. 18, 2018

(54) CONTROL OF INLET TEMPERATURE FOR CONVERSION STEP

(71) Applicant: Haldor Topsøe A/S, Kgs. Lyngby (DK)

(72) Inventors: Christian Henrik Speth, Lynge (DK); Emil Andreas Tjärnehov, Malmö (SE)

(73) Assignee: Haldor Topsøe A/S, Kgs. Lyngby (DK)

(21) Appl. No.: 15/767,709

(22) PCT Filed: Dec. 7, 2016
(86) PCT No.: PCT/EP2016/080010

§ 371 Date: Apr. 12, 2018

(30) Foreign Application Priority Data
Dec. 7, 2015 (DK) PA 2015 00785

(51) Int. Cl. F22B 35/00

(52) U.S. Cl. CPC F22B 35/00; C10J 2300/1884

(57) ABSTRACT

The present relates to a method for controlling the inlet temperature Tᵢ to a conversion process, said method comprising the steps of: Providing a feed for a conversion process; In a first temperature control step regulating the temperature of the feed in a waste heat boiler; In a second temperature control step injecting a water stream into the feed downstream the waste heat boiler in an amount and/or at a temperature to obtain the desired inlet temperature into the conversion process.

The size of waste heat boilers (WHB) has a significant influence on cost as well as maintenance of many process plants.

In a first aspect of the present invention is provided a method and plant allowing the use of a WHB with volume less than volume typical employed in process plants.

In a second aspect of the present invention is provided a method and plant wherein the capacity requirements to process condensate treatment may be reduced

These and other advantages are provided by a method for controlling the inlet temperature (Tᵢ) to a converter, said method comprising the steps of
Providing a feed for a conversion process
In a first temperature control step regulating the temperature of the feed by indirect heat exchange in a waste heat boiler,
In a second temperature control step injecting a water stream into the feed downstream the waste heat boiler.

As the temperature of the feed is controlled in two steps the requirements to the waste heat boiler in the first temperature control step are different compared to known processes wherein only the waste heat boiler is used to bring down the temperature of the feed to the desired inlet temperature. When the temperature is further adjusted in the second temperature control step the waste heat boiler may be designed to have a higher outlet temperature which has the advantage that the heat transfer area in the boiler is reduced.

If the water stream is boiler feed water and/or process condensate from one or more processes in the plant wherein the method is implemented, it is possible to use existing water sources in the plant. Furthermore, when process condensate is used the amount of process condensate from downstream processes which need to be send to waste water treatment may be significantly reduced as the process condensate is introduced in the second temperature control step.

In many advantageous embodiments the conversion is a high-temperature shift conversion.

The feed may for example be the effluent from a secondary reformer or an autothermal reformer (ATR) or e.g. a tubular reformer

The present method may for example be applied in an ammonia plant, a methanol plant or another type of chemical plant comprising a reformer.

By adjusting the temperature of the water stream to a temperature appropriate for cooling the feed stream prior to introduction into the feed at the second temperature control step it is possible to adjust the temperature of the feed at the second temperature control step by means of the amount of water added and/or by the temperature of the water added in the second temperature control step.

For example the added water has a temperature of 0-200 C.

Preferably the temperature of the feed for the conversion process is measured downstream the waste heat boiler upstream the conversion step to ensure that a desired inlet temperature of the feed is met. If the temperature of the feed differs from the preferred inlet temperature the amount and/or temperature of the water added to the feed at the second temperature control step can be regulated to achieve a desired inlet temperature.

Preferably the temperature of the feed after the first temperature control step is higher than the desired inlet temperature Tᵢ whereby the second temperature control step can be used to fine tune the temperature of the feed to achieve a desired inlet temperature. Furthermore, when the feed temperature after the first temperature control step is higher than the desired inlet temperature Tᵢ no steps for raising the feed temperature are required.

The load conditions of the plant and thereby the conditions in the conversion step may influence the optimal inlet temperature to a given reactor/convertor. This means that the inlet temperature Ti of the feed for the conversion process in various embodiments may be regulated based on plant load conditions.

As the steam/carbon (S/C) ratio of the feed stream is increased by adding water in the second temperature control step the present method may advantageously be applied in a plant or process requiring or benefiting from a reduced S/C factor upstream the second temperature control point.

The invention provides additionally a plant comprising a reformer, a first temperature control point, a second temperature control point, a reactor/converter such as a high temp converter), one or more temperature measuring means, wherein the first temperature control point comprises a waste heat boiler and the second temperature control point comprises means for adding water to a feed stream for the converter. Preferably the plant is arranged for the method described herein. The feed stream in the plant may be the effluent from a secondary reformer, or e.g. an ATR or a tubular reformer.

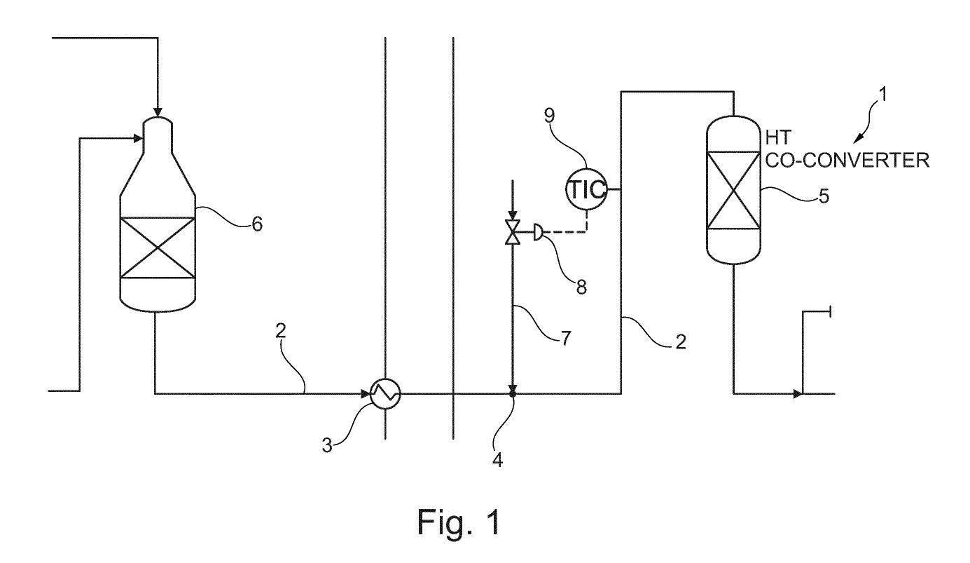

FIG. 1 shows an exemplary plant section 1 and illustrates the method according to the present invention.

The plant comprises a feed stream 2 which passes through a first temperature control step 3 and a second temperature control step 4 before being fed to a conversion step 5. In the present example the feed stream is the effluent from a secondary reformer 6 and the conversion 5 is a high temperature conversion.

The injection of the water 7 into the second temperature control step may be controlled by means of a valve 8. The valve 6 may receive/be controlled by one or more temperature sensors e.g. from a TIC 9.

In the first temperature control step 3, a waste heat boiler (WHB) may for example be a 120 B WHB wherein the WHB temperature control at least partly is exchanged by temperature control through water injection at a second temperature control step.

In the present example the temperature of effluent from the reforming step (the feed) is approximately 1050 C. After the first temperature control point the temperature is approx. 425 C and after the second temperature control point the feed has reached a desired inlet temperature Tᵢ=360 C.

The effluent from the conversion step may e.g. be sent to a second boiler and for any further processing.

1. Method for controlling the inlet temperature Tᵢ to a conversion process, said method comprising the steps of
Providing a feed for a conversion process
In a first temperature control step regulating the temperature of the feed in a waste heat boiler,
In a second temperature control step injecting a water stream into the feed downstream the waste heat boiler in an amount and/or at a temperature to obtain the desired inlet temperature into the conversion process.

2. Method according to claim 1, wherein the water stream is boiler feed water and/or process condensate from one or more process steps.

3. Method according to claim 1, wherein the conversion is a high-temperature shift conversion.

4. Method according to claim 1, wherein the temperature of the water stream is 0-200 C.

5. Method according to claim 1, wherein the temperature of the feed for the conversion process is measured upstream the conversion process.

6. Method according to claim 1, wherein the temperature of the feed after the first temperature control step is higher than the inlet temperature Tᵢ.

7. Method according to claim 1, wherein the inlet temperature Tᵢ of the feed for the conversion process is adjusted based on optimal temperature condition and/or reactor/conversion condition.

8. Method according to claim 1, applied in a plant or process with a reduced S/C ratio upstream the BWR.

9. Plant comprising a reformer, a first temperature control point, a second temperature control point, a reactor, one or more temperature measuring means, wherein the first temperature control point comprises a waste heat boiler and the second temperature control point comprises means for adding water into a feed stream for the reactor.

10. Plant comprising a reformer, a first temperature control point, a second temperature control point, a reactor downstream of the first and second temperature control point, one or more temperature measuring means, wherein the plant is arranged for the method according to claim 1.
